(19) United States
(12) Patent Application Publication
(10) Pub. No.: US 2013/0262333 A1
(43) Pub. Date: Oct. 3, 2013

(54) Systems and Methods for Identity Authentication Via Secured Chain of Custody of Verified Identity

(71) Applicant: DOCUMENT SECURITY SYSTEMS, INC., Rochester, NY (US)

(72) Inventors: David Wicker, Dansville, NY (US); Michael Caton, Oakfield, NY (US); Michael Roy, Webster, NY (US); Timothy Trueblood, Pittsford, NY (US); David Reitano, Honeoye, NY (US); Nicole Acton, Churchville, NY (US)

(73) Assignee: DOCUMENT SECURITY SYSTEMS, INC., Rochester, NY (US)

(21) Appl. No.: 13/839,759

(22) Filed: Mar. 15, 2013

Related U.S. Application Data
(60) Provisional application No. 61/616,416, filed on Mar. 27, 2012.

(51) Int. Cl. G06Q 50/26; G06Q 10/00

(52) U.S. Cl. CPC G06Q 50/265; G06Q 10/00
USPC 705/325

(57) ABSTRACT

A method for authenticating an identity of a test taker is provided. An online registration portal allows test takers to enter registration information including an uploaded picture. The registration information is sent to a trusted verifier, such as a school administrator or teacher, who verifies the picture matches the registration information. A secured registration ticket is then generated that includes the picture and one or more embedded security features. The registration ticket is mailed to the student in a tamper-evident enclosure with instructions to present the sealed mailer at the testing site for admission. The test proctors then unseal the registration document and confirm the authenticity of the registration ticket and that the person seeking entry matches the verified photo on the ticket before allowing entry.

### CROSS-REFERENCE TO RELATED APPLICATIONS

This application claims priority to, and the benefit of, U.S. Provisional Patent Application No. 61/616,416, filed Mar. 27, 2012, the content of which is hereby incorporated herein by reference in its entirety.

### FIELD

The present disclosure generally relates to document protection methods and products, and more particularly systems and methods for authenticating identities of test takers seeking admission to a testing site via authenticated registration documents including photo identification.

### BACKGROUND

Unless otherwise indicated herein, the materials described in this section are not prior art to the claims in this application and are not admitted to be prior art by inclusion in this section.

In order to ensure that the results of standardized tests are accurately attributed to the correct students, administrators of standardized tests generally endeavor to verify the identity of their test takers. In some examples test proctors admit test takers only after examining photo identification, such as a driver's license. By examining the photo ID, the proctor determines whether the person bearing the photo ID is the same as someone registered for the examination. So long as the name on the presented photo ID matches a list of pre-approved names for the administration of the test, and the picture on the photo ID matches the person bearing the ID, the person is generally admitted to the test site.

In recent years, the use of falsified photo IDs has allowed some would be test takers to hire others to take their tests on their behalf under their name. In fact, individuals who are able to achieve exceptional test scores on standardized tests have been able to earn money by impersonating others while taking tests. Thus, test admission procedures that rely on photo IDs as a sole means of identity verification are prone to scandal by those with access to falsified photo IDs, especially because test administrators/proctors are not generally familiar with their test takers identities in advance.

In addition, other systems and schemes for allowing access to secured locations commonly rely principally on photo identification to match pre-approved lists of names. For example, admission to passenger boarding areas, exclusive parties, ticketed events, etc., may be carried out by allowing entrance to individuals with photo IDs with names matching names on a preapproved list. Thus, conventional schemes for admitting individuals to secured locations are vulnerable to manipulation by falsified photo IDs.

Security features are embedded in documents such as official and/or valuable documents by incorporating security features in the documents that are modified upon reproducing the document to thereby inhibit unauthorized copies of the documents from being made. Such security features can include latent features that are largely indistinguishable within the background of the document on an original, but which become distinguishable in a reproduction of the document such as in a scanned reproduction of the document. By embedding features that distinguish an original document from reproductions thereof, counterfeit versions and other unauthorized copies can be more readily detected. Thus, such documents including embedded security features offer an indicator of authenticity to ensure that a particular printed version of the document is an original.

In applications such as commercial paper documents, security features are typically incorporated in a background of the document with latent security features embodied as words that will appear in reproductions of the commercial paper document. In reproductions of the document, the latent security features become visible, which allows unauthorized copies to feature words such as “void” or “copy” to indicate it is not an original. However, the background of the commercial paper document is generally static with pertinent information being printed, typed, or rendered over or adjacent the static background.

### SUMMARY

According to some aspects of the present disclosure, a method and associated system for authenticating an identity of a test taker is provided. An online registration portal allows test takers to enter registration information including an uploaded picture. The registration information is sent to a trusted verifier, such as a school administrator or teacher, who verifies the picture matches the registration information. A secured registration ticket is then generated that includes the picture and one or more embedded security features. The registration ticket is mailed to the student in a tamper-evident enclosure with instructions to present the sealed mailer at the testing site for admission. The test proctors then unseal the registration document and confirm the authenticity of the registration ticket and that the person seeking entry matches the verified photo on the ticket before allowing entry.

In some examples, the authenticity of the registration document can be verified though use of a suitable visual aid and/or a smart device. For instance a visual aid may be a lens with a pattern of variable opacity at a spatial frequency that corresponds to a pattern of a latent image situated in a background so as to be substantially indistinguishable on the registration document. When such a lens is overlaid, the latent image can be distinguishable from its background due to, for example, preferentially transmitting light corresponding to one or the other. Moreover, the visual aid may include a smart device, such as a camera-equipped mobile phone, tablet, another computing device, etc. The smart device may include, and/or be in communication with: a camera, a processing system, and an electronically controlled display or another user-interface output (e.g., speakers, haptic feedback system, etc.). Such a smart device may then capture an image of the multi-layer card (and the latent image therein) process the resulting image to identify the latent image, and then provide an indication of the identification results, such as by displaying an indication of such results. Thus, test proctors (or other personnel regulating access to a location) can use a camera-equipped smart device to verify the authenticity of a registration document, and determine to grant access to a particular location (or otherwise take actions dependent on verifying the identity of the individual) based on such authenticity determination.

According to some aspects of the present disclosure, a method of verifying an identity of an individual for an admission process includes receiving registration information for the individual. The registration information can include at least a picture of the individual. The method can include generating an authenticated registration document including at least some identifying information for the individual and an image based on the received picture of the individual. The method can include sending the authenticated registration document to the individual according to contact information for the individual. A person can present the authenticated registration document to seek entry to a secured location, and the method can include comparing the image on the authenticated registration document with the person bearing the document to determine whether the person bearing the authenticated registration document is the same as the individual associated with the authenticated registration document.

According to some aspects of the present disclosure, a system for verifying an identity of an individual for an admission process is provided. The system includes at least one registration server, a printer, and a mailing system. The at least one registration server includes one or more processors configured to receive registration information for an individual via an internet-based interface. The registration information can include at least a picture of the individual. The one or more processors can be configured to transmit at least a portion of the registration information to a trusted verifier to inquire whether the picture is an accurate representation of the individual. The one or more processors can be configured to dynamically generate one or more security features as raster images via an internet-based security feature generation system. The one or more processors can be configured to generate an authenticated registration document including at least some identifying information for the individual, an image based on the received picture of the individual, and the dynamically generated one or more security features responsive to receiving a message from the trusted verifier confirming that the picture is an accurate representation of the individual. The printer can be configured to print the generated authenticated registration document. The mailing system can be configured to convey the printed authenticated registration document to a mailing address based on the received registration information.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

The foregoing and other advantages of the invention will become apparent upon reading the following detailed description and upon reference to the drawings.

FIG. 1 is an information flowchart for an exemplary test admission and authentication and registration system including a secured chain of custody for an authenticated admission ticket.

FIG. 2 is another information flowchart of identifying exemplary registration documentation submitted by a test taker to a test administrator to gain admission to a test site.

FIG. 3 is a flowchart demonstrating identity authentication via secured chain of custody for an authenticated admission ticket.

FIG. 4 is a flowchart demonstrating dynamic generation of security features for inclusion in the authenticated admission ticket from a cloud-based service.

FIG. 5 is another flowchart demonstrating generation and distribution of authenticated admission ticket to a test taker.

FIG. 6 is a block diagram of an example system for allowing a consumer to print an authenticated physical document incorporating dynamically embedded security features delivered via the internet.

FIG. 7 is a flow chart demonstrating dynamic generation of a digital image file configured to be an embedded security feature in a physical document.

### DETAILED DESCRIPTION

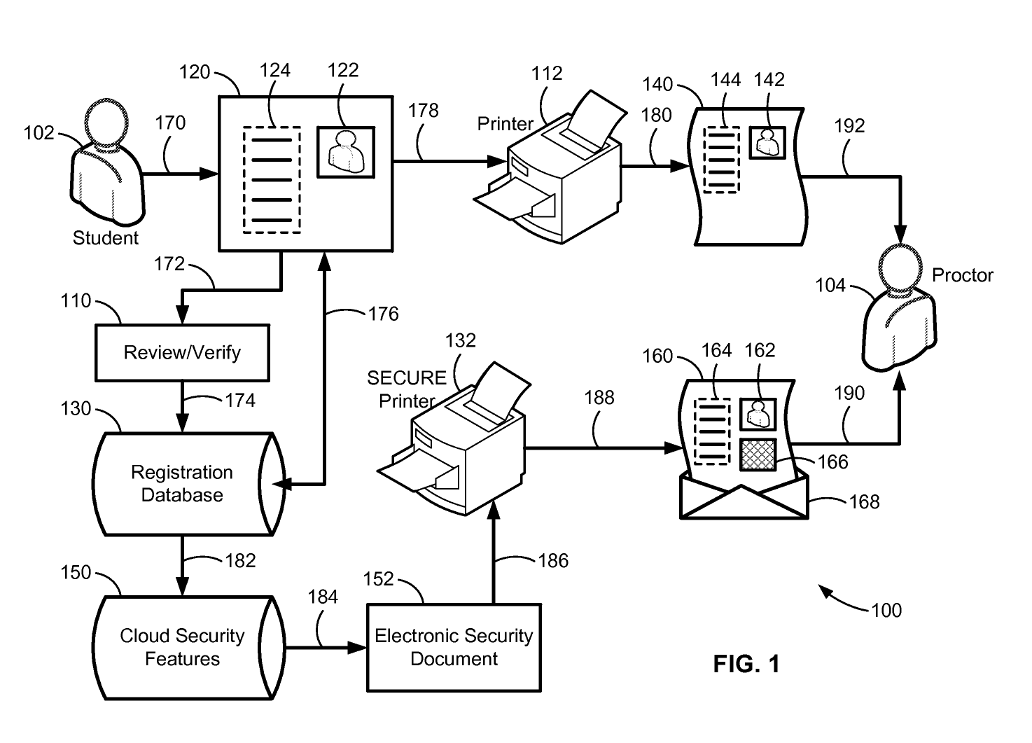

FIG. 1 is an information flowchart for an exemplary test admission and authentication and registration system 100 including a secured chain of custody for an authenticated admission ticket 160. The system 100 is described by way of example in reference to a student 102 registering for entry to a testing site for a standardized test that is administered by a proctor 104, however, it is specifically contemplated that aspects of the present disclosure extend to systems and schemes for authenticating the identity of individuals in connection with admitting those individuals to secured locations. Thus, in general, the student 102 can be considered an entry seeker, and the proctor 104 can be considered an entry determiner.

In the system 100, the student 102 registers for admission to a standardized test via a registration interface 120. The student 102 (or someone acting on behalf of the student 102, such as a parent, guardian, etc.) enters text-based registration information 124, and a picture 122. The text-based registration information 124 can include biographical identifying information such as name, address, date of birth, school(s) attended, graduation year or expected graduation year, etc. The text-based registration information 124 can also include information useful in placing students in a standardized testing center, such as whether they are right-handed or left-handed, etc. The text-based registration information 124 can also include information relating to the student's preferred testing site(s) and/or preferred testing time(s) and/or date(s). In some embodiments, the picture 122 is a photo of the student 102 suitable for allowing the student to be identified on the basis of the picture 122. In some embodiments, the picture 122 is a picture of the student's head and face suitable for a photo identification similar to those commonly used in photo identification documents, such as driver's licenses, passports, etc.

In some embodiments, the registration interface 120 can be internet-based 120, such as a website configured to receive text entries corresponding to registration information 124 and configured to receive an uploaded digital image file of the picture 122. In some embodiments, the registration interface 120 can optionally be configured to determine a time or date stamp associated with the uploaded digital image file and only accept digital image files that are within a specified time range, such as image files with dates within 1 year or within 6 months, for example. In some embodiments, the registration interface 120 can optionally prompt the student 102 to capture the picture 122 in real time via a camera, such as a web-cam, associated with a computer system providing the registration interface 120. In some embodiments, the uploaded digital image file can be processed via an image processing system such as a facial recognition system to determine whether the photograph meets minimum quality standards for focus, face dimensions (measured in pixels), etc. In some embodiments, the registration interface 120 can reject uploaded pictures 122 that do not meet minimum quality standards for size, focus, etc., as determined by the image processing system, and prompt the student 102 to upload a different picture.

In some embodiments, the registration interface 120 can be an electronic interface provided via a closed system associated with test administrators not accessible to the general public or via the internet. For example, a registration kiosk can be established at schools, college fairs, or other registration sites to allow the student 102 to enter the registration information 124 and picture 122.

Once the registration information 124 is entered and the picture 122 is uploaded to the registration interface 120, the information is electronically transmitted or otherwise conveyed to the standardized test administrators (176) where the information is loaded in a registration database 130 maintained by the system 100. In some embodiments, the registration database 130 can be associated with a server operating a website for the registration interface 120.

In some embodiments, the registration interface 120 is a paper-based system rather than an electronic interface, and the student 102 completes a registration form to enter the text-based registration information 124 and attaches a recent physical photograph as the picture 122. The completed form and physical photograph are then mailed or otherwise conveyed to the standardized test administrators (176) where the information is entered in the registration database 130.

The registration information 124 and associated picture 122 are analyzed in the registration database 130 and trusted identity verifier(s) 110 are identified for the student 102 based in part on the registration information 124. In some examples, the trusted verifier 110 is an administrator or teacher at the school the student 102 attends. In some examples, the trusted verifier 110 can be a home-room teacher for the student 102 or another individual associated with the student's school able to readily identify the student 102. In some examples, the student 102 identifies the school they attend in the registration information 124, and the test administrators then contact the school directly to identify suitable trusted verifiers for the student 102 (and similarly for each student that submits a registration).

The registration database 130 submits a query 172 to the identified trusted verifier 110 asking the trusted verifier 110 whether the picture 122 is an accurate representation of the student 102 and whether the identity of the student 102 is accurately represented by the received biographical information included in the registration information 124. To increase efficiency the query 172 to the trusted verifier 110 does not generally include the entirety of the received registration information 124 and may include only the name of the student 102 and expected graduation year as well as the picture 122. The query may also include an image based on the picture 122, such as a resized version of the picture 122 so as to decrease the file size of the query 172, etc. The query 172 is generally submitted to the trusted verifier 110 electronically, such as by email or via a secure internet-based interface to allow for efficient processing and responses from the trusted verifier 110.

As shown in the information flowchart of FIG. 1, the query 172 can also be generated directly from the registration interface 120 such that the query 172 is submitted in parallel with the transmission 176 of the registration information 124 and picture 122 to the registration database 130. Alternately, the query 172 can be submitted from the registration database 130 once the information is received.

The query 172 is analyzed by the trusted verifier 110 who determines whether the picture 122 accurately represents the student 102 and whether the identity of the student 102 matches the submitted registration information. The trusted verifier 110 sends a message 174 to the registration database 130 indicating whether the picture 122 is an accurate representation of the student 102 and is correctly associated with the received biographical information (e.g., the student's name). If the message 174 confirms the identity of the student 102, the registration database 130 includes for students which have been verified, and the identity of the student 102 according to the received picture 122 is thereby more robustly associated with the student 102 than it would be without the trusted verifier's 110 confirmation.

In some embodiments, if the message 174 does not confirm the identity of the student 102 or indicates that the picture 122 is not a recent, clear, or accurate representation of the student 102, the system 100 can take further steps to confirm the identity of the student 102. For example, the student 102 can be contacted and requested to submit a second, more recent, or more accurate picture, which can then be submitted to the trusted verifier 110 for confirmation. In another example, upon receipt of a non-confirming message 174, the student 102 can be instructed to appear in person before a suitable person (such as a school administrator, a test administrator, a public notary, etc.) with documentation suitable to verify their identity and with a recent picture, or can provide arrangements to have a picture taken by, or in the presence of, the suitable person.

Upon submission of the completed registration information 124 and picture 122, the registration interface 120 allows for printing a registration confirmation document 140 via a printer 112 associated with a computer system for accessing the registration interface 120. The registration interface 120 accordingly generates printer instructions 178 to the associated printer 112. The printer 112 prints the registration confirmation document 140 according to the printer instructions 178 (180). The registration confirmation document 140 includes printed text information 144 based at least in part on the registration information 124 and an image 142 based at least in part on the submitted picture 122. By including the photo 142, the registration confirmation document 140 includes an embedded indicator of the identity of the student 102. In some embodiments, the registration interface 120 allows for printing the registration confirmation document 140 only after the submitted information is verified by the message 174. That is, the registration confirmation document 140 may only be printed after some time has passed to allow for the trusted verifier 110 to confirm the accuracy of the submitted registration information 124 and picture 122. In some embodiments, the registration confirmation document 140 can be printed immediately upon submitting the information to the registration interface 120.

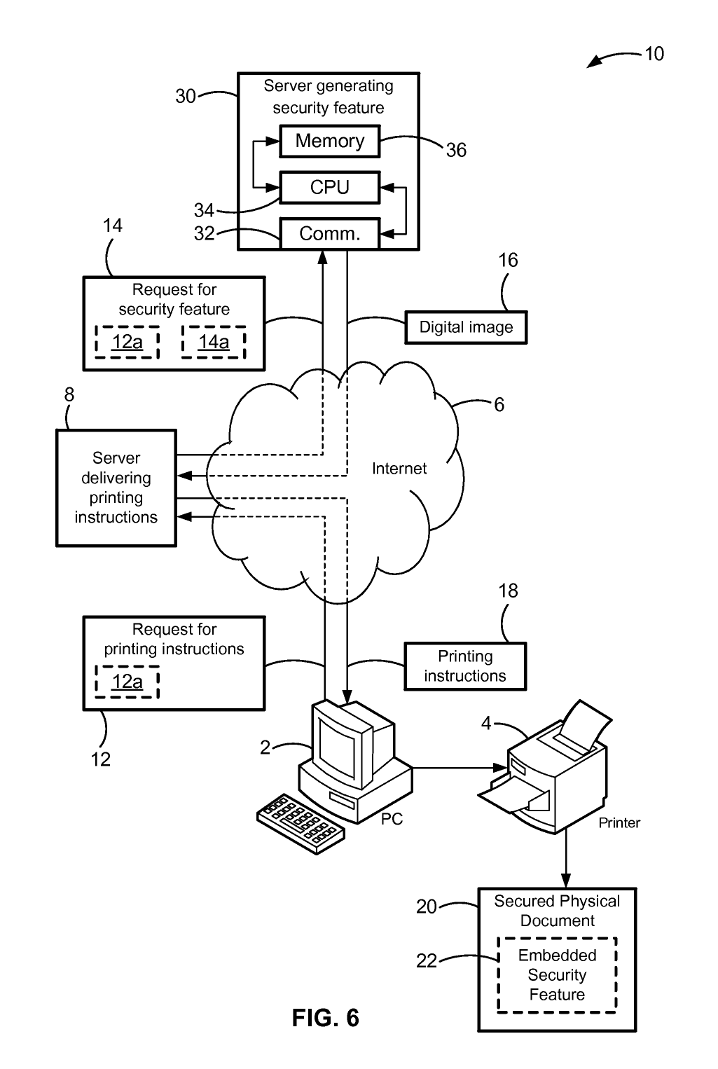

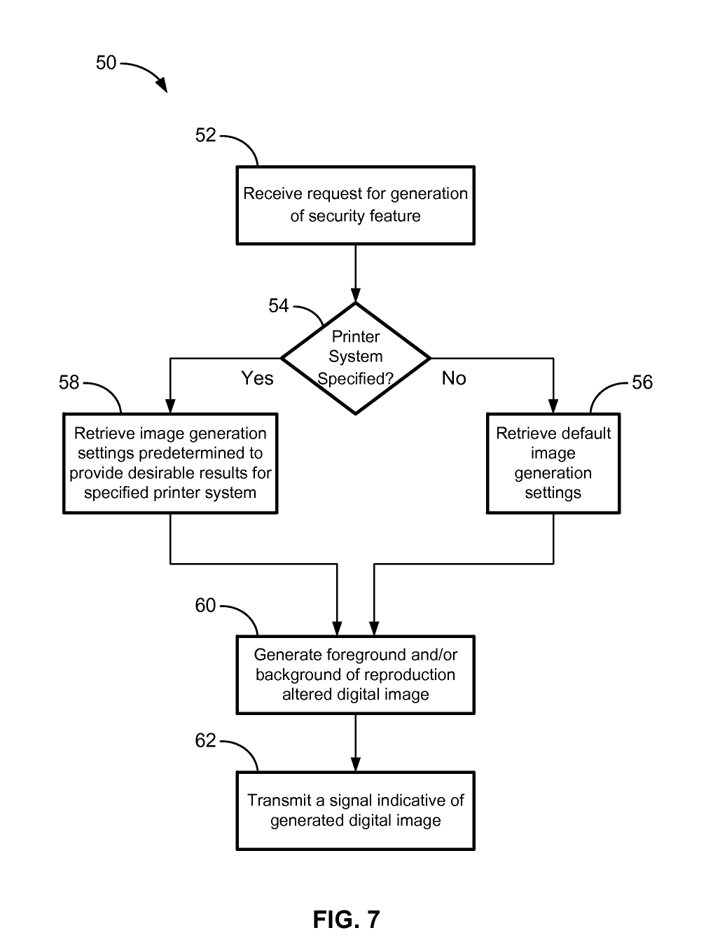

The system 100 also generates an authenticated registration document 160 (“secured registration ticket”). The verified information in the registration database 130 is transmitted (182) to a cloud-based security feature provider 150. The transmission 182 to the cloud-based security feature provider 150 includes information derived at least in part from the submitted registration information 124 and/or picture 122. The transmission 182 can be a request for generation of an electronic security document 152 with embedded security features. The cloud-based security feature provider 150 generates the electronic security document 152 (184) including embedded security features, a photo, and printed text information. The cloud-based security feature provider 150 can include a remote server with a processor operating instructions suitable to generate raster images suitable to be included as embedded security features in a printed document. An exemplary cloud-based security feature generation system for dynamically generating security features is shown and described in connection with FIGS. 6 and 7 below.

Printing instructions 186 corresponding to the generated electronic security document 152 are sent to a secure printer 132. The secure printer 132 prints the authenticated registration document 160 according to the printer instructions 186 (188). The secure printer 132 can be a printer associated with the cloud-based security provider 150 or the registration database 130 or a separate secure printing facility. Alternatively, as discussed below, the secure printer can be a consumer-level printer, such as located in the student's 102 home, and operating according to securely delivered printing instructions to generate a secured document. The printed authenticated registration document 160 includes a photo 162 and text information 164 that are based at least in part on the verified information stored in the registration database 130. The text information 164 can include, for example, biographical information for the students such as the student's name, address, etc. The photo 162 can be based on the submitted picture 122 as verified by the trusted verifier 110 and can optionally be modified via re-sizing, color correction, orientation, etc. to allow the face of the student 102 portrayed in the photo 162 to be roughly standardized relative to similar authenticated registration documents. The authenticated registration document 160 also optionally includes one or more embedded printed security features 166 generated by the cloud-based security feature provider 150.

The authenticated registration document 160 is enclosed in a secure envelope 168 and sent to the student 102 according to contact information for the student 102. The authenticated registration document 160 can be sent by postal mail to a mailing address for the student 102 or the student's school or the student's parent or guardian as specified by the verified registration information stored in the registration database 130. The mailing can be carried out by an automated or partially automated mailing system associated with the secured printer 132 and in communication with the registration database 130 (to receive the mailing information).

While the embedded security features 166 on the authenticated registration document 160 serve to discourage altering or producing unauthorized copies of the document, the secure envelope 168 can also include tamper-evident features to indicate whether the envelope 168 is opened. To further discourage tampering, the secure envelope 168 can be mailed with instructions that opening the envelope 168 voids the enclosed authenticated registration document 160.

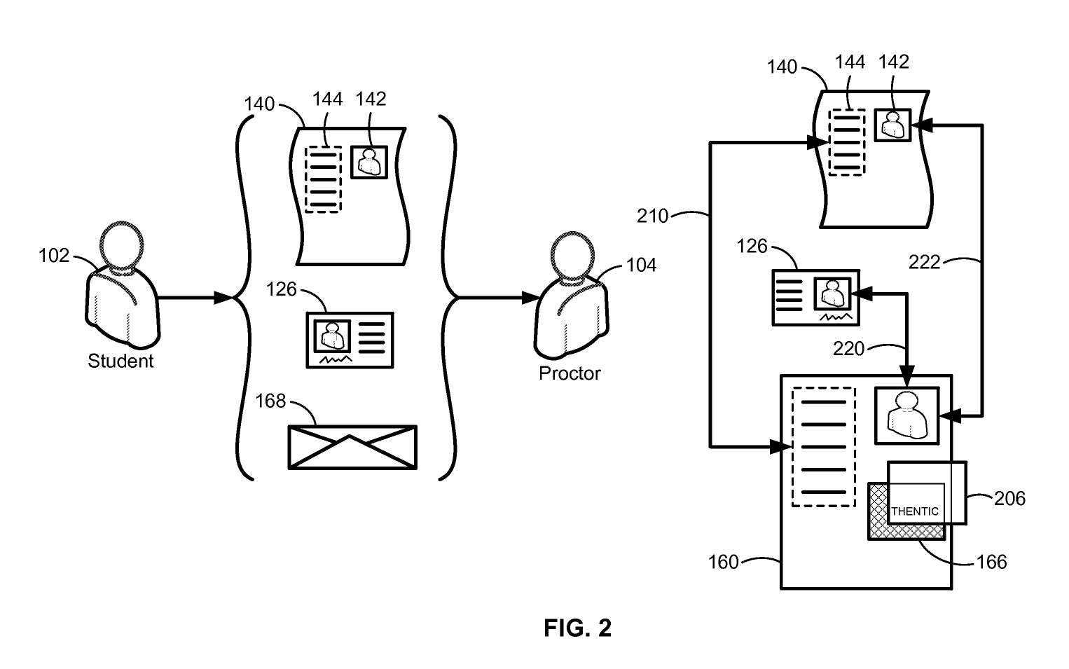

To gain entry to the testing site, the student 102 presents (190, 192) both the printed registration confirmation 140 and the authenticated registration document 160. The authenticated registration document 160 may be in the unopened, sealed tamper-evident envelope 168. Alternatively, the authenticated registration document 160 may be printed at the student's 102 home according to instructions for generating a secured document, as described further below. The proctor 104 analyzes the submitted documents 140, 160 to determine whether to admit or deny the student 102 to the testing site, which is discussed further in connection with FIG. 2 below.

The embedded printed security features 166 can include a latent image embedded in an integrated background setting and indistinguishable from the background in an original printed version of the authenticated registration document 160. In some embodiments, the latent image can be distinguishable in a reproduction of the original printed version so as to provide authenticity to the authenticated registration document by distinguishing the original printed version from the reproduction. In some embodiments, the latent image can be distinguishable in an original printed version of the document via a specialized viewer or visual aid configured to differentially interfere with the latent image or the background surrounding the latent image. The latent image can be indistinguishable in a reproduction of the original printed version so as to provide authenticity to the authenticated registration document by distinguishing the original printed version from the reproduction. In some embodiments, the latent image and/or the integrated background setting can be composed of line-screen patterns of printed elements oriented with selected line frequencies, print densities, colors, etc. to achieve the desired effects. Furthermore, the specialized viewer or visual aid can have a characteristic line frequency corresponding to a line frequency of a line screen pattern of the latent image or the background such that the latent image is distinguishable from the background in the original printed version by differential interference patterns between the latent image and the background.

In some embodiments, the embedded security feature 166 can include a latent image configured to reveal, via the specialized viewer, information necessary to gain admission to the testing site. For example, the embedded security feature 166 can be embedded with the test registration number for the student 102 embedded within a latent image that is revealed with a specialized viewer. Because the latent image of the test registration number is not visible in an unauthorized reproduction of the authenticated registration document 160, the student 102 will not gain admission to the testing site unless the authenticated registration document 160 is an original printed version.

The embedded security feature 166 may also be authenticated using a smart device. The smart device may include, and/or be in communication with: a camera, a processing system, and an electronically controlled display or another user-interface output (e.g., speakers, haptic feedback system, etc.). Such a smart device may then capture an image of the embedded security feature 166, process the resulting image to identify the latent image, and then provide an indication of the identification results, such as by displaying an indication of such results. Thus, the test proctors 104 can use a camera-equipped smart device to verify the presence of the security feature 166 in the presented document 160, and thereby authenticate the document, and by extension, verify the identity of the student 102. Example systems and methods for using a camera-equipped smart device, such as a mobile phone, tablet, or other processing system including (or in communication with) a camera, and suitable image processing module(s) are disclosed, for example, in commonly assigned U.S. Patent Application No. 61/719,385, filed Oct. 27, 2012, the content of which is hereby incorporated herein by reference in its entirety

FIG. 2 is another information flowchart identifying exemplary registration documentation submitted by a student 102 to a test proctor 104 to gain admission to a test site. The student 102 presents the printed registration confirmation 140, the sealed envelope 168 containing the authenticated registration document 160, and a valid photo ID 126. The proctor determines that the authenticated registration document is an authentic original by verifying that the tamper-evident seals show that the envelope 168 was not previously opened and/or by evaluating the embedded security features 166 for authenticity on the authenticated registration document 160 once the envelope 168 is opened. For example, the proctor 104 may view the embedded security feature 166 through a specialized viewer 206 (or smart device) to determine whether a latent image is visible through the viewer 206. Because the latent image is visible with the specialized viewer 206 only on an original printed copy of the authenticated registration document 160, and not in an unauthorized reproduction, the presence of the latent image as revealed by the viewer 206 indicates the authenticated registration document 160 is an authentic original. In the example shown in FIG. 2, the viewer 206 reveals the word “AUTHENTIC” (although only the portion “THENTIC” is visible). The latent image and/or its integrated background setting are formed from a line screen pattern with a characteristic line frequency corresponding to a characteristic line frequency of the viewer 206 such that the viewer provides differential interference patterns between the latent image and the background so as to allow the latent image to be distinguishable. In the example shown in FIG. 2, the latent image is the word “AUTHENTIC,” although in other implementations, the latent image can include information specific to the particular student 102, such as the student's test registration number, name, etc. In some embodiments, the security feature 166 advantageously includes covert latent images that are not readily apparent without the specialized viewer 206 such that the student 102 is not readily aware of the presence of the security feature 166 or of its precise nature.

Once the proctor 104 is satisfied that the authenticated registration document 160 is an unaltered and authentic version, the proctor 104 can be satisfied that the information reflected on the authenticated registration document 160 accurately reflects the verified information from the registration database 130. The proctor 104 compares the verified information on the authenticated registration document 160 with the photo ID 26 (220) and the printed registration confirmation 140 (210, 222). For example, the photo on the authenticated registration document 160 can be compared with the photo 142 on the printed registration confirmation 140 (222) or can be compared with the photo ID 126 (220). Of course, the photo on the authenticated registration document 160 can also be compared with the student 102 bearing the documents 140, 160 and ID 126. Furthermore, the verified biographical (“personal”) information on the authenticated registration document 160 can be compared with the text information 144 on the printed registration confirmation 140 (210) and/or with information on the photo ID 126.

Discrepancies in any of the comparisons 210, 220, 222, or upon comparison of the verified information on the authenticated registration document 160 with the student 102 bearing it may be grounds for denying the student 102 entry to the test site and/or voiding the student's test registration. In addition, failure to present the authenticated registration document 160, which is indicated as authentic by the embedded security feature 166, or failure to present the authenticated registration document 160 while still in the sealed tamper-evident envelope 168 may be grounds for denying the student 102 entry to the test site and/or voiding the student's test registration. On the other hand, the proctor may allow the student 102 to the test site upon concluding that the authenticated registration document 160 is authentic and the verified information included thereon matches the identity of the student 102 bearing the document 160.

As described herein, the embedded security features 166 and/or the tamper-evident sealed envelope 168 allow the proctor 104 to determine that the presented authenticated registration document 160 is an authentic one, and not an unauthorized copy that may have been subject to alterations or other tampering. Both the security feature 166 and the tamper-evident envelope 168 provide assurance that the authenticated registration document 160 is the one originally printed by the secure printer 132, but in tandem (i.e., by requiring both) the assurance of authenticity of the authenticated registration document 160 is even stronger.

Thus, some embodiments of the present disclosure provide a system and associated operation scheme to allow for verification of the student's identity by an independent trusted verifier 110. In particular, some embodiments provide for a secure chain of custody of an authenticated registration document 160 including the verified information from the secured printer 132 to the proctor 104. The secure chain of custody can be provided by enclosing the authenticated registration document 160 in the secured envelope with tamper-evident seals with instructions that the registration is void if the envelope is opened before the test. The secure chain of custody can also be provided by embedding security features in the printed authenticated registration document 160 that allow the proctor 104 to distinguish the original printed version of the authenticated registration document 160 from an unauthorized copy. In some embodiments, both aspects can be combined to provide an even more secure chain of custody by rendering the authenticated registration document 160 with embedded security features 166 and enclosing the authenticated registration document 160 in the sealed, tamper-evident mailer 168. By allowing the proctor 104 to verify that the presented document is the original version printed from the secure printer 132, the proctor 104 is able to rely on the information on the authenticated registration document 160 (including the photo 162) as having an accuracy verified by the trusted verifier 110. The verified information conveyed to the proctor 104 via the secured chain of custody thereby prevents test takers from entering a test site under an assumed name and with falsified photo IDs.

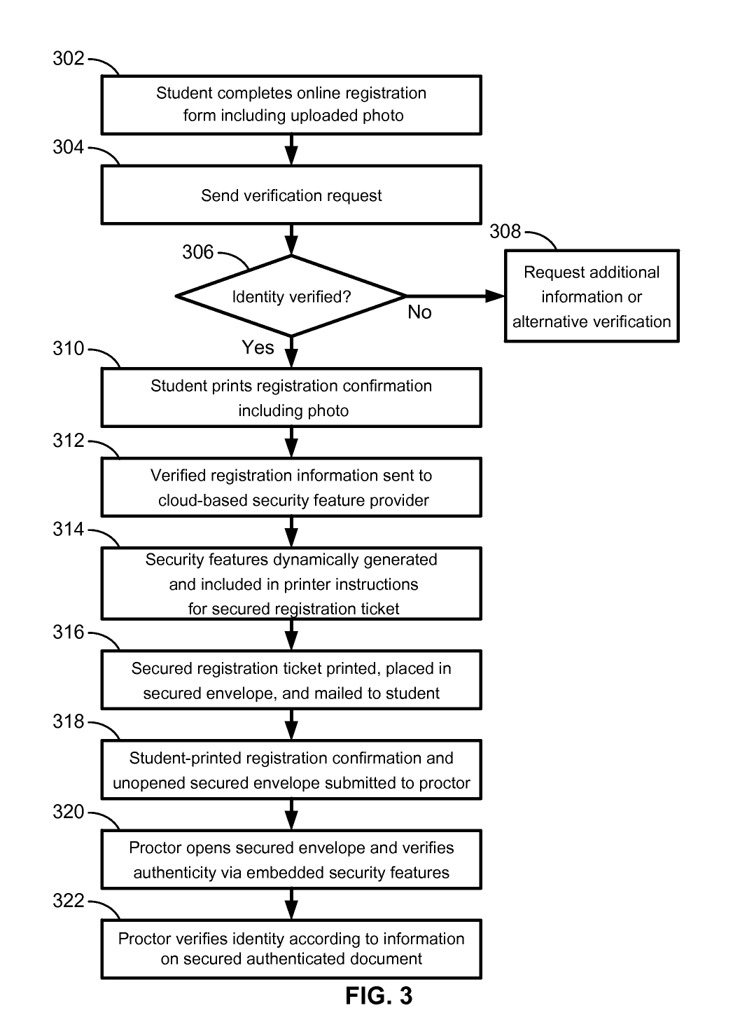

FIG. 3 is a flowchart demonstrating identity authentication via a secured chain of custody for an authenticated admission ticket. The operations described in connection with the flowchart of FIG. 3 will be described in reference to the system 100 of FIG. 1 for clarity. The student 102 completes an online registration form and includes an uploaded photo (302). The information from the registration form is received at the registration database 130 and a verification request is sent to a trusted verifier 110 (304). The trusted verifier 110 analyzes the verification request 304 and determines whether the registration information 124 submitted by the student 102 matches the identity indicated by the picture 122 (306). If the identify is not verified, additional information is requested from the student 102 or the student's identity is verified by alternative means (308). If the identity is verified, the student 102 prints registration confirmation 140 including the picture (310). In some embodiments, the registration confirmation 140 can be printed (310) regardless of the outcome of the identify verification 306, and can occur, for example, between the online registration form (302) and the verification request (304). The verified registration information (or a portion thereof) is sent to a cloud-based security feature provider (312).

The cloud-based security feature provider dynamically generates security features to include in authenticated (“secured”) registration ticket (314). The dynamic generation of security features can be carried out via cloud-based security feature providers similar to those described below by way of example in connection with FIGS. 6 and 7. The dynamically generated security features can be raster images configured to be printed as embedded security features in a printed document, or can be printer instructions for a printed document with embedded security features. The secured registration ticket 160 is then printed, placed in a secured envelope 168, and mailed to the student 102 (316). The secured envelope 168 can include tamper-evident seals. To gain admission to the testing site, the student 102 presents the printed registration confirmation 140, the unopened envelope 168 containing the secured registration ticket 160, and a photo ID to a test site proctor 104 (318). The proctor 104 opens the secured envelope 168 and verifies the authenticity of the enclosed secured registration ticket 160 via the embedded security features 166 (320). The proctor may verify the authenticity by analyzing the security features with a specialized viewer and/or by photo analysis facilitated by a suitable smart device, for example. The proctor 104 verifies the identity of the student 102 according to the information on the secured registration document 160 (322). The proctor 104 can then admit or deny the student 102 on the basis of the information on the secured document 160.

According to some embodiments of the present disclosure, a secure chain of custody of an authenticated document with verified information content is provided. For example, the authenticated document 160 includes verified information (i.e., the registration information 164 and photo 162). The chain of custody of the authenticated document 160 (and thus, the information on the authenticated document 160) is secured from the secured printer 132 and associated mailing system to the proctor 104. Because the authenticated document 160 is placed in a tamper-evident sealed envelope 168 (or other suitable tamper-evident enclosure), and kept sealed until presented to the proctor 104, the proctor 104 can determine whether the authenticated document 160 was removed from the envelope 168 prior to being presented to the proctor 104. Thus, the test site proctor 104 relies on the verification of the identity of the student 102 provided by the trusted verifier 110, rather than solely on the verification of identity provided by a single photo ID, which may be falsified.

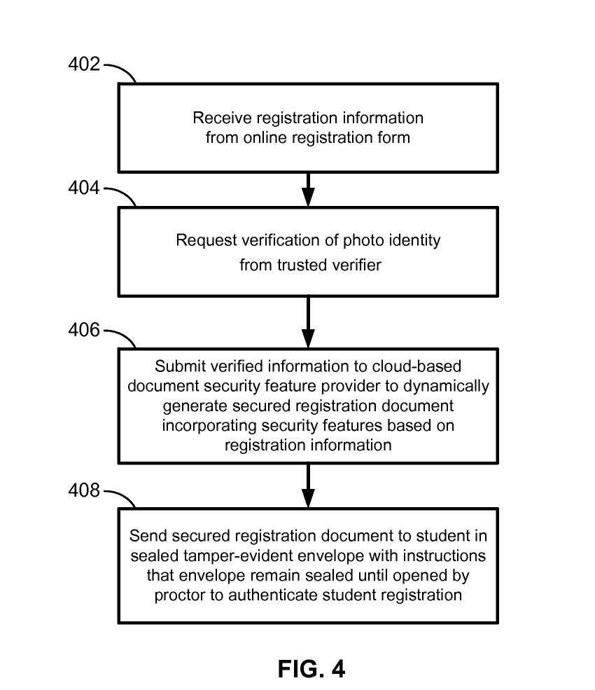

FIG. 4 is a flowchart demonstrating dynamic generation of security features for inclusion in the authenticated admission ticket from a cloud-based service. Registration information is received from an online registration form (402). The identity of the registered student is verified by a trusted verifier (404). The verified information is then submitted to a cloud-based document security feature provider to dynamically generate a secured registration document incorporating security features based in part on the received registration information (406). The cloud-based security feature provider can be a dynamic security feature provider similar to those described herein in connection with FIGS. 6 and 7. In some embodiments, the embedded security features included in the secured registration document are sufficient to allow an original printed version of the registration document to be distinguished from a reproduction. In some embodiments, the embedded security features include latent images formed from line screen patterns that are revealed by visual aids with corresponding line screen frequencies to differentially interfere with the latent image or its background such that the latent image is distinguishable. The secured registration document is printed and sent to the student in a secured tamper-evident envelope with instructions that the envelope should remain sealed until opened by a test site proctor or administrator during admissions to the test site (408).

In some embodiments, the embedded security feature is configured to be verified using a camera-equipped smart device and suitable image processing system, which may be implemented by hardware, software, and/or firmware within the smart device or by a remote server in communication with the smart device. As a result, the embedded security feature may include printed elements to make the security feature for analysis by a smart device, such as contrasting print elements to cause a smart device and/or associated imaging system to focus on the embedded security feature during image capture. Examples of embedded security features suitable for analysis by a camera-equipped smart device are disclosed, for example, in commonly assigned U.S. Patent Application No. 61/719,385, filed Oct. 27, 2012, the content of which is hereby incorporated herein by reference in its entirety.

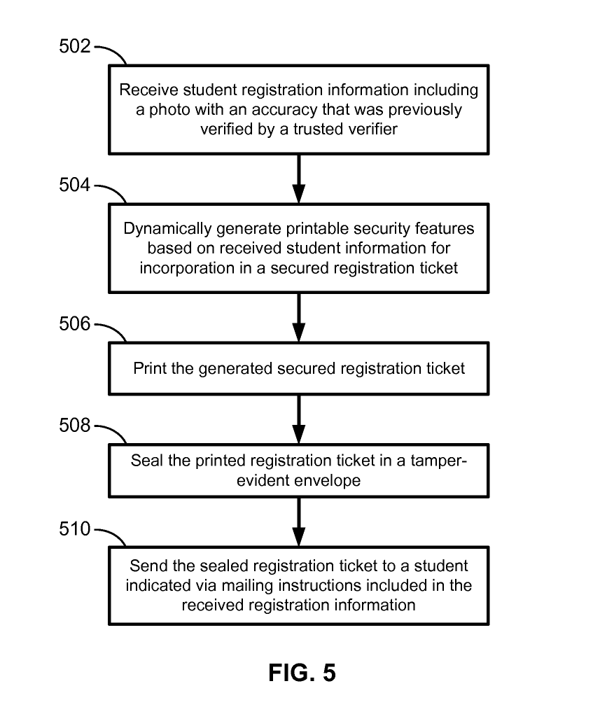

FIG. 5 is another flowchart demonstrating generation and distribution of authenticated admission ticket to a test taker. Student registration information including a photo with an accuracy previously verified by a trusted verifier is received (502). Printable security features based in part on the received student information and suitable for incorporation in a secured registration ticket are generated in real-time (i.e., dynamically) (504). The generated secured registration ticket is printed (506). The printed registration ticket is sealed in a tamper-evident envelope or other enclosure (508). The sealed registration ticket is sent to the student according to mailing instructions indicated by the received registration information (510). In an alternative process, the registration ticket may be printed at home according to cloud-delivered instructions for printing a secured document (e.g., according to a locally installed printer driver that communicates with a remote server to receive printing instructions). The resulting secured document printed by the user (e.g., the student 102 or another individual) can thereby be configured to include embedded security features that are rendered differently in the resulting original version of the document than in a reproduction thereof.

Generally, the flowcharts of FIGS. 3-5 provide exemplary implementations of schemes for admitting students to a secured test site on the basis of verified identities authenticated by a registration document with a secured chain of custody. Additionally, some embodiments of the present disclosure provide authenticated registration documents including integrated photo-based identities of students seeking admission to test sites such that students are admitted (or denied admission) to test sites on the basis of their photos included with the authenticated registration document and not solely on the basis of a photo ID, which may be falsified. However, particular implementations may include only a subset of the distinct blocks laid out in each of the flowcharts. In addition, some implementations may allow some actors (e.g., test administrators) to perform functions indicated by some blocks, which other actors (e.g., school administrators, parents, students, etc.) to perform functions indicated by other blocks. By way of example, the flowchart of FIG. 4 provides some blocks that may be accomplished largely by a test administrator, while the flowchart of FIG. 5 provides some blocks that may be accomplished largely by a cloud-based secured document service.

In some embodiments of the present disclosure, students register on line for a standardized test (e.g., SAT, ACT, etc.) and include an uploaded photograph. The test administrator's system can generate a student registration confirmation that includes the student's photograph. The student's home room teacher (or guidance counselor, coach, or another trusted verifier, etc.) can receive the student registration information via email and reply with a message indicating confirmation of the student's identity (or denying confirmation). The test administrator can send student registration information including student photo to a cloud-based web application which can generate a secured student registration ticket that can be transmitted back to the test administrator's system. The secured registration ticket can be secured with embedded security features that allow an original printed version of the document to be distinguished from a reproduction and can include embedded latent images visible with a visual aid and/or camera-equipped smart device and associated image processing system. The latent images can be indistinguishable in a reproduction, even with the same visual aid such that the presence of the latent image (as revealed by the viewer) indicates the authenticity of the document. For example, the secured registration ticket can include Authentiguard Pantograph 4000 and Prism technologies available from Document Security Systems.

The test administrator prints the secured student registration ticket and place in a sealed security envelope that will be mailed to the registered student. To gain entry to the test site, the registered student presents a valid photo identification, their registration confirmation document, and the secured registration ticket in the unopened mailer to the test proctor. The test proctor can validate student identity and authenticity of the sealed registration ticket using provided lenses or other suitable visual aids, smart devices, etc. which will reveal, for example, latent information such as the student's test registration number or a single word such as “AUTHENTIC.” Embedded printed security features can also ensure that no illegal copies or modifications were made to the secured registration ticket.

In some embodiments, the photo of the student will be printed on both the secured registration document and on a roster or similar list of individuals approved for admission and maintained by the proctor. Thus, the photo of the student can be compared both from the secured registration ticket and from the roster or similar list. Furthermore, the photo can also be attached to students' official and/or unofficial score reports sent to the student, the student's high school(s), and/or college(s).

In some embodiments, a sealed document is used for identification of a person in other instances where a state driver's license, school id, passport, or similar photo ID may be suspect, or as an additional safety check to guard against the potential of falsified photo IDs. For instance, a secured document associated with a trusted verifier can be used to regulate access control to secured locations in a variety of contexts. The person logs in to a computer to enter personal information via a registration interface and submits a photograph of themselves, or other identity-specific information (e.g., thumbprint, other biometrics, etc.). This digital information (or at least some fraction thereof) is sent to a trusted verifier who can be identified, at least in part, from the information entered into the registration interface. For example, a trusted verifier for a student may be the student's homeroom teacher, guidance counselor, etc. The trusted verifier confirms that the listed personal information for the person is correctly matched to the photograph (or other information) and that the photograph is a clear, recent, and otherwise accurate representation of the person. After the trusted verifier verifies the personal information and photograph, the data is sent to a secure cloud for further download to a printer that prints a secured document with the photograph and at least some of the personal data. The secured document can optionally also include one or more embedded printed security features to allow the authenticity of the document to be verified as an original and/or to embed certain information in the secured document that can be revealed with specialized viewer(s) and/or smart device(s).

Accordingly, the systems and techniques of the present disclosure may find application in a broad range of different contexts, such as by employers, governments, and the like that are faced with challenges of verifying identities of various persons. For example, governments, private entities, and others may use the systems and techniques described herein for verifying an individual's identity based on a secured chain of custody from a trusted verifier, and use a token of that trusted verifier's judgment (e.g., a printed document bearing security features and/or sealed in a tamper-evident enclosure, etc.) to authenticate the individual. As such, the systems and techniques disclosed herein allow for a generic identity verification and related access controls. For example, employers may grant access to secured locations (e.g., research labs, vaults, etc.) and/or secured information (e.g., networked databases, file rooms, firewall permissions, etc.) on the basis, at least in part, on a verification of an individual's identity from a trusted verifier, which verification can be delivered via a secured chain of custody. In another example, governments may grant access (e.g., to physical locations, to information repositories, etc.) to individuals based at least in part on a verification of an individual's identity from a trusted verifier, which verification can be delivered via a secured chain of custody.

As such, any of the systems and processes (and combinations thereof) described above in the context of FIGS. 1-5 may be applied to scenarios in which the student is replaced by an employee or job applicant and the test proctor by an employer, for example (e.g., in which the employer regulates access to locations and/or information on the basis of individuals' verified identities). Additionally or alternatively, the student may be an applicant or recipient and the test proctor a grantor (e.g., in which the grantor distributes goods or services on the basis of individuals' verified identities). Other examples are also possible, as the examples provided herein are provided by way of explanation and illustration, rather than limitation.

In some embodiments, the secured registration document is addressed, sealed and mailed to an address specified in the personal information. For example, an address for a student may be the parents, guardians or school of the student. The secured document can be enclosed in a tamper-evident inner envelope of a mailer with instructions that unsealing tamper-evident envelope mailer voids the secured document. By enclosing the secured document in a sealed tamper-evident envelope, the contents of the secured document is maintained covert until opened by someone seeking to authenticate the identity of the person on the basis of the trusted verifier's verification. For example, a test proctor can verify the identity of a student at the test site for actual comparison to the student in real time. Secondarily, the viewer (or other specialized reader such as a smart device, for example) can be employed to authenticate information either before the mailer is opened or afterwards for comparison to the personal data located on the inside of the mailer.

In some embodiments, the authenticated secured document can be configured to printed from an individual's computer, which is accessible over the internet, rather than mailed in a secured envelope. In such an example, the authenticated secured document may be delivered via a specialized printer driver that allows the authenticated secured document to be printed one time only, such as described by way of example in connection with FIG. 6. The authenticated secured document also includes embedded security features sufficient to authenticate the document as an original printed version and thereby prevent the document from being reproduced or otherwise altered.

As such, the systems and techniques of the present disclosure provide for multiple forms of secured chain of custody for conveying an identity-verification judgment of a trusted verifier. In some examples, the secured chain of custody is carried out by printing out a document that includes an indication of the trusted verifier's judgment, and then mailing such document in a tamper-evident enclosure. So long as the tamper-evident enclosure remains sealed, the contents of the enclosure can be used at a later date to learn the judgment of the trusted verifier. The process of opening the tamper-evident enclosure can assure the opener that the contents of the enclosure are in an unaltered state, and, by extension, the judgment of the trusted verifier reflected thereon is in an unaltered state. However, a tamper-evident enclosure by itself for secured chain of custody is, in many respects, a single use technique, because once the tamper-evident is opened during a verification procedure, the tamper-evident enclosure shows evidence of having been opened and thus no longer provides a subsequent user assurance that the contents have not been tampered with.

As a result, some embodiments provided herein provide for a secured chain of custody of a trusted verifier's judgment, as indicated on a document, by including printed security features on such document. Moreover, the printed security features may be used alone or in combination with a tamper-evident mailer to allow for subsequent users (e.g., test proctors and the like) to be assured that the document is an authentic original document and thus has not been tampered with. By verifying that no tampering has occurred (based on printed security features indicating the document is an original and/or by a tamper-evident enclosure indicating the document has been sealed within since its delivery), such users are able to rely upon the identity judgment of the trusted verifier as documented by such document.

FIG. 6 is a block diagram of an example system 10 configured to allow a user to print an authenticated (“secured”) physical document 20 incorporating one or more dynamically embedded security features 22 delivered via the internet 6. The system 10 includes a personal computer 2 having a user interface for displaying content and receiving user inputs. The personal computer 2 is communicatively coupled to a printer 4. In some embodiments, a remotely located first server 8 is configured to deliver printing instructions 18 in response to a request 12 from the computer 2. In some embodiments, the printing instructions are utilized by the computer 2 and/or printer 4 to cause a physical secured document 20 to be printed on the printer 4. In some embodiments, the secured document 20 incorporates an embedded security feature 22, which is dynamically generated by a second server 30 communicatively coupled to the first server 8 for delivering a digital image indicative of the embedded security feature.

According to some embodiments, the computer 2 can be communicatively coupled to the printer 4 via parallel, USB, serial, or wireless connection technologies. In some embodiments, the printer 4 is a consumer-level printer system that is commercially available through, for example, an office supply store or similar venue for purchasing electronics for home use. In some embodiments, the printer 4 can be, for example, an ink jet printer or a laser jet printer, and can produce physical printed documents with resolutions of approximately 300 to 600 dots per inch. Additionally or alternatively, the printer 4 can produce physical printed documents with resolutions exceeding 600 dots per inch. In some embodiments, the computer 2 includes an internet connection port (not separately shown) for coupling the computer to the internet 6 or other network via signals to send data packets to and/or from the computer 2 and one or more of the remotely located servers 8, 30.

In some embodiments, the first server 8 can be configured as a web-based printer driver that is operative to provide instructions 18 to the computer 2 for printing the secured physical document 20 via the printer 4. In some embodiments, the first server 8 can communicate with a printer driver software module preinstalled on the computer 2. Such a printer driver software module can be configured to provide printing of documents where externally controlling features of the printing process is desirable. For example, such a preinstalled printer driver module can be configured to only allow printing a limited number of copies (e.g., one copy) of a particular document.

In some embodiments, the remotely located first server 8 is configured to receive a request (“query”) 12 for printing instructions from the computer 2. The request 12 for printing instructions can optionally be initiated in response to a user input on the computer 2, such as, for example, entering one or more key strokes or selecting a selectable region of a graphical user interface. Additionally or alternatively, the first server 8 can be configured to send instructions to the computer 2 without any relation to a user action, such as at a predetermined interval or in response to an external action or signal that is not associated with the computer 2 or its user.

In some embodiments, where the request 12 is transmitted to the first server 8, a data load embodying the request can optionally include customization data 12a. The customization data 12a can include, for example, indicators specifying information about the printer system 4 (e.g., type, model, manufacturer, etc.) communicatively coupled to the computer 2. Additionally or alternatively, the customization data 12a can include indicators specifying the content of the secured document being requested, which can be, for example, indicators specifying or information concerning the secured and/or unsecured portions of the document. Additionally or alternatively, the customization data 12a can include indicators of identifying information and/or information specifying features of the computer 2 and/or its user, and such data can optionally be provided covertly (i.e., without indicating its transmission to such a user).

According to some embodiments, the first server 8 generates signals indicative of printer instructions 18, which can be information adapted to communicate directly with a printer in a printer-specific language, e.g., XPS file type, or can be signals that allow a software printer driver module to create printer language instructions to cause the printer 4 to print the physical secured document 20. According to some embodiments, the first server 8 is configured to deliver instructions 18 for printing the secured document 20. In order to enhance the security of the resulting printed document 20, however, the first server 8 communicates with the security image dynamic generation second server 30, via, for example, the internet 6 or other network, to receive digital images suitable to be integrated in the secured document 20 as the embedded security features 22. In some embodiments, the embedded security features 22 are reproduction altered regions, which will be explained further herein below.

In some embodiments, the first server 8 sends a request 14 to the second server 30 including a data payload including information indicative of a security feature to be generated by the second server 30. The request 14 can include information from the request 12 sent by the computer 2, or portions thereof. For example, the request 14 can include some or all of the customization data 12a, or can include data derived in whole or in part from the customization data 12a. The request 14 can additionally or alternatively include additional customization data 14a which is provided by the first server 8 to further specify the contents and/or generation parameters of the requested security feature. In some embodiments, the additional customization data 14a can include information specifying the identity of the first server 8 or specifying other information useful for diagnostic and/or forensic purposes.

According to some embodiments, the second server 30 is configured to generate a digital image 16 incorporating reproduction-altered security features based on the received request 14. The second server 30 includes a communication interface 32 for sending and receiving signals to and from the second server 30. According to some embodiments, the server 30 includes a processor 34 and a memory module 36. According to some embodiments, the processor 34 is communicatively coupled to both the memory 36 and the communication interface 32. The second server 30 receives the request 14 and its associated data payload via the communication interface 32. According to some embodiments, the processor 34 operates to construct a digital image based at least in part on the received data 14. The resulting digital image is configured to be integrated in the printed document 20 as the embedded security feature 22. In some embodiments, the generation of the digital image via the processor 34 is carried out by generating one or more foreground features comprising a line screen pattern. In some embodiments, the processor 34 also generates a background pattern comprising an array of lines, dots, elements, irregular shapes, non-uniform features, and/or one or more line screen patterns.

As used herein, a line screen pattern is generally a pattern including parallel, narrow lines that are characterized by (at least) a line frequency. The line frequency of a line screen pattern is a spatial frequency characterizing the number of lines per inch (LPI) in a particular line screen pattern. The line frequency can be measured by, for example, measuring the number of lines traversed along a direction perpendicular to the orientation of the lines in the line screen pattern, and then dividing the measured number of lines by the distance traversed. The line screen pattern can be generated with line thickness such that the amount of space between lines in the pattern is equal to the amount of space occupied by the lines (e.g., the distance between nearest sides of adjacent lines is nearly equal to the thickness of the lines). Additionally or alternatively, the line screen pattern can be generated with lines having a standardized line thickness determined to provide desirable results with a particular printing system and/or reproduction system. Additionally or alternatively, the line screen pattern can be generated with lines having a minimum achievable line thickness. In some embodiments, the minimum achievable line thickness can be achieved by utilizing a primary color from the printing system in order to avoid utilizing mixed colors, which may thicken the lines. In some embodiments, the minimum achievable line thickness will be influenced by characteristics of a printing system, such as, for example, the resolution (dots per inch) of the printing system.

According to some embodiments, one or more image generation settings can be adjusted based on the identity of the printer system 4 to provide desirable results. In some embodiments, the image generation settings can be empirically determined by, for example, testing a range of possible combinations of image generation settings on a variety of different printer systems and identifying the printer settings that work best. Additionally or alternatively, once a subset of printer systems expected to be employed in the system 10 have been tested and desirable image generation settings have been determined, conclusions can be drawn regarding a remainder of printer systems expected to be utilized in the system 10. Indications of the printer systems and their corresponding determined image generation settings can then be stored in the memory 36 of the second server 30. Such information can be stored using, for example, a look up table to associate identified printer systems (or classes, types, or manufacturers thereof) with one or more image generation settings empirically determined to produce desirable results for those printer systems. Additionally, the memory 36 can store default image generation settings to be used to generate the digital image 16 when no printer system is specified by the data payload of the request 14, or when the identified printer system is not included in the lookup table.

The second server 30 transmits signals indicative of the digital image 16 back to the first server 8 via the internet 6 to be incorporated in the printing instructions 18 returned to the computer 2 by the first server 8. The digital image 16 can be transmitted as a raster image file (e.g., PNG, JPG, BMP, etc. file types) or can be transmitted as a vector image file (e.g., EPS, etc.), or can be transmitted as signals indicative of either of these, such as by an encrypted message. Once the data payload 16 indicating the digital image file is returned to the first server 8, the first server 8 incorporates (“integrates”) the digital image in the printing instructions 18 for the secured document and sends the printing instructions 18 to the computer 2.

Some embodiments of the system 10 illustrated in FIG. 6 thus provide functionality previously unavailable: to print documents 20 with dynamically generated embedded security features 22 on home-based (“consumer-level”) printers 4 in a user's home or other location connected to the internet 6. Some embodiments of the present disclosure advantageously provide systems for generating embedded security features on documents printed via consumer level printer systems, such as, for example, printer systems creating documents with resolutions of 300 to 600 dots per inch. Some embodiments of the present disclosure advantageously include dynamically generated content, customizable content, or settings optimized for use on particular printer systems. Aspects of the present disclosure are thus applicable to a broad range of situations where electronically delivering secured documents to a user is desirable. For example, according to some embodiments local governments may endeavor to electronically deliver building permits to be posted at construction sites, and may desire such building permits, when printed via a user's consumer level printing device, to incorporate embedded security features to allow for verification of their authenticity. In another example, businesses and vendors may endeavor to electronically deliver coupons or discounts, and may desire such documents to incorporate embedded security features. Other examples will be readily apparent for applications of this technology to electronically deliver dynamically generated security features to be embedded in a printed document adapted for consumer level printing technology.

The nature of the embedded security features can take several forms. In some embodiments, the embedded security feature is a reproduction altered security feature. As used herein, the term “reproduction altered” is used to describe a printed field having a foreground and a background which, when reproduced, causes the foreground and background to be altered with respect to one another relative to their relationship in an original version of the printed field. In some embodiments, an embedded security feature can include a latent image in its foreground which is not readily distinguishable, with the naked eye, from a background visually integrated setting. In some embodiments, the latent image can be revealed on an original printed version with assistance of a viewing aid (and/or camera-equipped smart device and associated processing system) that is configured to allow the latent image to become distinguishable; however, upon reproduction, the latent image becomes indistinguishable from the background with the same viewing aid. Thus, some embodiments of the embedded security feature allow for information to be securely embedded within a document, only readily revealed with assistance of a particular viewing aid, and for the information to be effectively destroyed upon reproducing (“copying”) the document.

In some embodiments, the embedded security feature can include a latent image that is not readily distinguishable from its surrounding background in an original printed version, but which becomes distinguishable in a reproduction of the original. As used herein, a reproduction generally refers to a physical copy of an original printed document reproduced using optical scanning technologies. In some embodiments, the embedded security feature can include a latent image that is not readily distinguishable from its surroundings in an original printed version, but which becomes distinguishable in an electronic display (“visual facsimile”) of an optically scanned version of the original printed document. For example, an electronic display can be employed to display, for example, barcodes for electronically delivered tickets, boarding passes, etc., on portable electronic devices such as phones, personal digital assistants, tablet computing devices, and/or mobile computer screens. Examples of some reproduction altered embedded security features are disclosed, for example, in commonly assigned U.S. patent application Ser. No. 11/839,657, filed Aug. 16, 2007, and published as U.S. Patent Publication No. 2008/0048433 on Feb. 28, 2008; U.S. patent application Ser. No. 11/744,840, filed May 5, 2007, and published as U.S. Patent Publication No. 2007/0257977 on Nov. 8, 2007; and U.S. patent application Ser. No. 11/495,900, filed Jul. 31, 2006, and published as U.S. Patent Publication No. 2007/0029394, the contents of each of which are hereby incorporated herein by reference in its entirety. Moreover, example systems and methods for using a camera-equipped smart device, such as a mobile phone, tablet, or other processing system including (or in communication with) a camera, and suitable image processing module(s) are disclosed, for example, in commonly assigned U.S. Patent Application No. 61/719,385, filed Oct. 27, 2012, the content of which is hereby incorporated herein by reference in its entirety.

FIG. 7 is a flow chart 50 demonstrating the dynamic generation of a digital image file configured to be included as an embedded security feature in a physical document. As shown in FIG. 7, a request (e.g., the request 14 shown in FIG. 6) is received to generate a security feature (52). The data payload of the request is analyzed to determine whether the request includes data specifying a printing system (54). If no printing system is specified, default parameters (“settings”) for generating the security feature(s) are retrieved (56). If a printing system is specified, parameters for generating the security feature(s) are retrieved which have been predetermined to provide satisfactory results with the specified printing system (58). Such parameters can be stored, for example, in a look up table within the memory 36 of the second server 30, with entries for various settings of print density, line frequency, etc. corresponding to various types of identified printer systems. The data payload of the request is examined further to determine whether particular content of the requested security feature is further specified by the request 14. For example, the size (e.g., pixel dimensions), desired reproducibility features, and/or desired content of any latent images in the foreground and/or background of the digital image may be indicated by the request 14. A digital image suitable for being embedded within a physical document as an embedded security feature is then generated according to the specified parameters (60). Signals are transmitted (e.g., the signals 16 shown in FIG. 6) to convey information indicative of the generated digital image to the requestor (62). The generated digital image can be generated and/or transmitted as a raster image file, such as a PNG, JPG, BMP, etc. or as a vector image file, such as EPS, etc. The signals conveying the generating digital image can optionally be encrypted to provide additional security.

The security features can additionally or alternatively include, for example, embedding authenticating information in the document such that copies of the original appear in an altered state relative to the original. A digital version of the document can include a hash value associated with an authorized version of the digital document, such that subsequently created versions of the digital document can be identified as unauthorized copies when their associated hash values do not match the original. The system advantageously allows for embedded security features to be generated on printed documents created via consumer level printing technologies. Aspects of the present disclosure advantageously allow for embedded information to be rendered as a raster graphics image that is dynamically generated to embed information that dynamically retrieved. The dynamic generation of the raster image can also be optimized according to particular printing technologies employed.

Many functions described herein may be implemented in hardware, firmware, or software. Further, software descriptions of the disclosure can be used to produce hardware and/or firmware implementing the disclosed embodiments. According to some embodiments, software and/or firmware may be embodied on any known non-transitory computer-readable medium having embodied therein a computer program for storing data. In the context of this disclosure, computer-readable storage may be any tangible medium that can contain or store data for use by, or in connection with, an instruction execution system, apparatus, or device. For example, a non-volatile computer-readable medium may store software and/or firmware program logic executable by a processor to achieve one or more of the functions described herein in connection with FIGS. 1-7. Computer-readable storage may be, for example, an electronic, magnetic, optical, electromagnetic, infrared, or semiconductor system, apparatus, or device, or any suitable combination of the foregoing. More specific examples of computer-readable storage would include but are not limited to the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. Further, although aspects of the present disclosure have been described herein in the context of a particular implementation in a particular environment for a particular purpose, those of ordinary skill in the art will recognize that its usefulness is not limited thereto and that the present disclosure can be beneficially implemented in any number of environments for any number of purposes.

In view of the exemplary systems described above, methodologies that may be implemented in accordance with the described subject matter will be better appreciated with reference to the various figures. For simplicity of explanation, the methodologies are depicted and described as a series of acts. However, acts in accordance with this disclosure can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be appreciated that the methodologies described in this disclosure are capable of being stored on an article of manufacture to facilitate transporting and transferring such methodologies to computing devices.

Although some of various drawings illustrate a number of logical stages in a particular order, stages which are not order dependent can be reordered and other stages can be combined or broken out. Alternative orderings and groupings, whether described above or not, can be appropriate or obvious to those of ordinary skill in the art of computer science. Moreover, it should be recognized that the stages could be implemented in hardware, firmware, software or any combination thereof.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

What is claimed is:

1. A method of verifying an identity of an individual for an admission process, the method comprising:
receiving registration information for the individual, the registration information including at least a picture of the individual;
generating an authenticated registration document including at least some identifying information for the individual and an image based on the received picture of the individual;
sending the authenticated registration document to the individual according to contact information for the individual; and
responsive to a person presenting the authenticated registration document to seek entry to a secured location, comparing the image on the authenticated registration document with the person bearing the document to determine whether the person bearing the authenticated registration document is the same as the individual associated with the authenticated registration document.

2. The method of verifying an identity of an individual of claim 1, further comprising:
transmitting at least a portion of the registration information to a trusted verifier to inquire whether the picture is an accurate representation of the individual, and
wherein the generating is carried out responsive to receiving a message from the trusted verifier confirming that the picture is an accurate representation of the individual.

3. The method of verifying an identity of an individual of claim 2, further comprising, responsive to receiving a message from the trusted verifier that the picture is not an accurate representation of the individual contacting the individual, via contact information included in the received registration information to request alternative verification of the identity of the individual.

4. The method of verifying an identity of an individual of claim 2, wherein the registration information includes information indicative of a school or workplace and the trusted verifier is associated with the school or workplace.

5. The method of verifying an identity of an individual of claim 1, wherein the registration information is digital information received via an internet-based registration interface, and wherein the picture of the test taker is a digital image file.

6. The method of verifying an identity of an individual of claim 1, wherein the picture is a physical photograph and the receiving includes scanning the physical photograph to generate a digital image file based on the physical photograph.

7. The method of verifying an identity of an individual of claim 1, wherein the generating the authenticated registration document includes dynamically generating one or more printed security features as raster images, via an internet-based security feature generation system, and including the security features in the generated document.

8. The method of verifying an identity of an individual of claim 1, wherein the generating the authenticated registration document includes embedding one or more printed security features in the registration document such that a latent image is indistinguishable in an original printed version of the document, and the latent image is distinguishable in a reproduction of the original printed version so as to provide authenticity to the authenticated registration document by distinguishing the original printed version from the reproduction.

9. The method of verifying an identity of an individual of claim 1,
wherein the generating the authenticated registration document includes embedding one or more printed security features in the registration document such that a latent image is distinguishable in an original printed version of the document via at least one of a visual aid configured to interfere with the latent image or a background surrounding the latent image or a camera-equipped smart device and associated processing system, and
wherein the latent image is indistinguishable in a reproduction of the original printed version so as to provide authenticity to the authenticated registration document by distinguishing the original printed version from the reproduction.

10. The method of verifying an identity of an individual of claim 9, wherein the visual aid has a characteristic line frequency corresponding to a line frequency of a line screen pattern of the latent image or the background such that the latent image is distinguishable from the background in the original printed version.

11. The method of verifying an identity of an individual of claim 9, wherein the latent image includes a representation of an admission number for gaining entry to the secured location, the method further comprising:
revealing the admission number from the authenticated registration document via the visual aid; and
allowing admission to the secured location to persons bearing the authenticated registration document responsive to determining that the revealed admission number corresponds with an entry in a list of approved admission numbers.

12. The method of verifying an identity of an individual of claim 9, wherein the latent image includes a representation of a number for gaining entry to the secured location, the method further comprising:
capturing an image of the printed security feature via a camera-equipped smart device;
processing the captured image to identify the latent image;
extracting, from the processed image, information indicative of the number for gaining entry; and
allowing admission to the secured location to persons bearing the authenticated registration document responsive to determining that the extracted information corresponds with an entry in a list of approved admission numbers.

13. The method of verifying an identity of an individual of claim 7, wherein the one or more printed security features includes at least one line screen pattern.

14. The method of verifying an identity of an individual of claim 7, further comprising, verifying the authenticity of the authenticated registration document, based at least in part on the embedded printed security feature prior to allowing entrance to the secured location.

15. The method of verifying an identity of an individual of claim 1, further comprising generating a list of approved individuals for admission for use in determining which persons to admit to the secured area, the list including identifying information and images for each approved individual.

16. The method of verifying an identity of an individual of claim 1, wherein the sending the authenticated registration documents is carried out via a postal service to convey the authenticated registration document to a mailing address associated with the individual and thereby transfer custody of the authenticated registration document according to the mailing address.

17. The method of verifying an identity of an individual of claim 1, wherein the sending the authenticated registration documents is carried out by securely electronically transmitting the authenticated registration document to the individual such that the authenticated registration document can be printed only once.

18. The method of verifying an identity of an individual of claim 1, further comprising printing the authenticated registration document via a secured printer.

19. The method of verifying an identity of an individual of claim 1, further comprising prior to sending the authenticated registration document to the individual, securing the authenticated registration document in a tamper-evident enclosure.

20. The method of verifying an identity of an individual of claim 18, wherein the tamper-evident enclosure is an inner envelope in a mailer including printed instructions that the sealed tamper-evident enclosure is to be presented for admission to the secured location.

21. The method of verifying an identity of an individual of claim 18, further comprising opening the sealed tamper-evident enclosure prior to the comparing.

22. The method of verifying an identity of an individual of claim 18, further comprising refusing admission to a person not bearing an authenticated registration document in a sealed tamper-evident enclosure.

23. The method of verifying an identity of an individual of claim 1, wherein the secured location is a testing site for a standardized test.

24. A system for verifying an identity of an individual for an admission process, the system comprising:
at least one registration server including one or more processors configured to:
receive registration information for an individual via an interne-based interface, the registration information including at least a picture of the individual;
transmit at least a portion of the registration information to a trusted verifier to inquire whether the picture is an accurate representation of the individual;
dynamically generate one or more security features as raster images, via an internet-based security feature generation system; and
responsive to receiving a message from the trusted verifier confirming that the picture is an accurate representation of the individual, generate an authenticated registration document including at least some identifying information for the individual, an image based on the received picture of the individual, and the dynamically generated one or more security features;
a printer configured to print the generated authenticated registration document; and
a mailing system configured to convey the printed authenticated registration document to a mailing address based on the received registration information.

25. The system for verifying an identity of an individual of claim 23, wherein the generated one or more security features includes one or more printed security features embedded in the registration document such that a latent image in the raster image is indistinguishable in an original printed version of the document, and the latent image is distinguishable in a reproduction of the original printed version so as to provide authenticity to the authenticated registration document by distinguishing the original printed version from the reproduction.

26. The system for verifying an identity of an individual of claim 23,
wherein the generated one or more security features includes one or more printed security features embedded in the registration document such that a latent image is distinguishable in an original printed version of the document via at least one of a visual aid configured to interfere with the latent image or a background surrounding the latent image or a camera-equipped smart device and associated processing system, and
wherein the latent image is indistinguishable in a reproduction of the original printed version so as to provide authenticity to the authenticated registration document by distinguishing the original printed version from the reproduction.

27. The system for verifying an identity of an individual of claim 25, wherein the visual aid has a characteristic line frequency corresponding to a line frequency of a line screen pattern of the latent image or the background such that the latent image is distinguishable from the background in the original printed version.

28. The system for verifying an identity of an individual of claim 25, wherein the latent image includes a representation of an admission number for gaining entry to the secured location.

29. The system for verifying an identity of an individual of claim 24, wherein the one or more printed security features includes at least one line screen pattern.

30. The system for verifying an identity of an individual of claim 23, wherein the mailing system is configured to secure the printed authenticated registration document within a tamper-evident enclosure.

31. The system for verifying an identity of an individual of claim 29, wherein the tamper-evident enclosure is an inner envelope in a mailer including printed instructions that the sealed tamper-evident enclosure is to be presented for admission to the secured location.

32. The system for verifying an identity of an individual of claim 23, wherein the secured location is a testing site for a standardized test.

33. A system comprising:
at least one server including one or more processors configured to:
receive identity information;
transmit at least a portion of the received identity information to a trusted verifier to inquire whether the identity information is associated with a particular individual; and
responsive to receiving a message from the trusted verifier confirming that the identity information is associated with the particular individual, convey a secured document to the particular individual.

34. The system of claim 32, wherein the system is further configured to dynamically generate at least one security feature, and wherein the at least one security feature is included in the secured document conveyed to the particular individual.

35. The system of claim 33, wherein the at least one security feature includes a reproduction altered security feature such that an original printed version of the secured document is verifiable as a non-reproduction.

36. The system of claim 32, wherein the identity information includes, at least, a picture of the particular individual.

37. The system of claim 32, wherein the secured document is conveyed the particular individual by sending printable instructions to allow the particular user to generate a printed version of the secured document.
